(19) United States
(12) Patent Application Publication
(10) Pub. No.: US 2005/0097403 A1
(43) Pub. Date: May 5, 2005

(54) USB interface and testing method thereof

(76) Inventor: Ker-Min Chen, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/689,408

(22) Filed: Oct. 20, 2003

(51) Int. Cl. G06F 11/00

(52) U.S. Cl. 714/43; 702/122

(57) ABSTRACT

A physical layer of a USB interface. A test signal generator generates a test signal. A signal sampling device coupled to the test signal generator samples the test signal and outputs the test signal after a predetermined time. A transmitter and a receiver coupled to a signal access the data of the transmission terminals. A USB transceiver macrocell coupled to the test signal generator, the transmitter and receiver converts the test signal to USB protocol, outputs a first converted signal through the transmitter, receives the first converted signal through the transmission terminals and the receiver, and converts the received first converted signal to a second converted signal. A comparator coupled to the USB transceiver macrocell and the signal sampling device compares the second converted signal with the test signal, and outputs an error acknowledging signal.

### BACKGROUND OF THE INVENTION

The present invention generally relates to USB interfaces. In particular, the present invention relates to a USB 2.0 interface and a testing method thereof.

### DESCRIPTION OF THE RELATED ART

Since 1994, a series of USB (Universal Serial Bus) specifications, targeting a highly flexible serial interface at a data transmission rate much higher than the 115 Kbps-230 Kbps, have been published for implementation following discussion and collaboration amongst many established computer and communication manufacturers. For example, one of the specifications is USB 1.1, which has a data transmission rate of 12 Mbps (Megabits per second). The serial interface technique must perform extra tasks such as transmission timing control, bidirectional data transformation between serial and parallel format, bit counting, and is therefore more complex and has an inherently lower data transfer rate than parallel interface technology. The associated benefits of serial interface technology, however, have lead to the enthusiastic adoption of USB. For example, with the adoption of differential low-level signal technology, the data transmission rate of USB has improved significantly. As the serial interface has a smaller number of signal wires than the parallel interface, the serial interface is generally simpler and the cost of its transmission cable is lower.

The USB specification also possesses benefits such as ease of use, simple connection, multimedia support, self-power, and the like. Additionally, the USB 1.1 standard supports the connection of multiple devices through a single interface cable, and PnP (Plug-n-Play) functionality is integrated in the Windows operating system. Therefore, USB 1.1 has been widely adopted in the microcomputer and computer-networking industry. The recent USB 2.0 specification achieves a higher data transmission rate of 480Mbps, while maintaining backward compatibility with the USB 1.1 standard. Thus, USB 2.0 is expected to promote further development of peripheral devices for the microcomputer and other associated components for the data-communication industry.

FIG. 1 is a block diagram of a conventional USB interface. The USB 2.0 transceiver (TXCVR) 10 includes the analog circuitry to handle the USB HS/FS (high speed/full speed) signaling. The USB 2.0 Transceiver Macrocell Interface (UTMI Logic) 12 is compliant with the Intel UTMI specification 1.09, which handles the low level USB protocol and signaling. The major tasks of UTMI Logic 12 are data and clock recovery, NRZI (NonReturn to Zero Inverted) encoding/decoding, bit stuffing/de-stuffing, USB 2.0 test mode support and serial/parallel conversion. The serial interface engine (SIE) 14 contains the USB packet ID and address recognition logic, and other sequencing and state machine logic to handle USB packets and transactions. The CLKGEN 16 is a clock generator, which generates a clock signal used by the logic blocks.

The CPU 18 essentially operates as a centralized controller of the USB chip. It may be an 8-bit micro controller operating in 15 MHz, 7.5 MIPS. After receiving a USB command, it decodes the host command, and then re-assigns tasks to the IDE engine 19, GPIO,. FIFO 20, and responds to the USB host with proper data/status information. The IDE engine 19 is extended from standard ATA/ATAPI (AT Attachment/AT Attachment Packet with Interface) protocol. It supports PIO mode, multiword DMA mode, and ultra DMA mode data transfers.

U.S. Pat. No. 6,480,801 discloses a universal serial bus test system comprising a test system that can be used to determine whether a selected USB device provides appropriate data in response to a set of standard device requests. According to the '801 patent, the test system performs a series of tests to validate the interface functions of a USB driver, which tests the device responses without having to create or compile a test program. The test system further comprises a test application and a test application driver. The test application driver interfaces with the USB driver of the USB system software. The USB system software also includes a host controller driver. The host controller driver interfaces with the host controller and thereby interfaces the software on the host system with the USB interconnect and USB devices. The test system incorporates a command line interpreter through which commands can be entered to perform selected tests on the USB system. The command line interpreter enables execution of commands in an operating system (e.g., Unix) shell without having to interrupt a USB testing or debugging session. The user may also enter commands and perform USB system testing remotely via a communications link between a client and a host computer.

U.S. Pat. No. 6,393,588 discloses a test apparatus for testing the functions of a USB hub under the control of a USB host computer. According to the '588 patent, the USB host computer issues a USB command during the test. The test apparatus includes a USB bus, an emulation device, a standard bus and a micro-controller device. The USB bus is coupled to the USB hub. The emulation device emulates a USB device connected to the USB bus. The standard bus is connected to the USB host computer. The micro-controller device is connected to the standard bus and the emulation device, respectively, to process a USB transaction corresponding to the USB command. The invention of the '588 patent provides a testing environment which is fully compliant with the Windows 98 environment.

Notwithstanding, the conventional methods are not suitable for a USB interface, such as USB 2.0, operating in high-speed mode at 480 Mbps. The USB 2.0 interface are not easily or practicably tested by a digital test machine during mass production, as it is difficult to input test vectors and probe the loop-back generated by the bi-directional 16-bit data bus. Another conventional method uses an analog tester or high-end test machine to test a USB chip operating in high-speed mode, the test machines are, however, very expensive.

### SUMMARY OF THE INVENTION

One object of the present invention is to provide a test method and a physical layer structure to reduce the test cost of the physical layer of the USB 2.0 interface and to expand the testing parameters from digital only, to both digital and analog during mass production.

To achieve the above-mentioned object, the present invention provides a USB interface. The USB interface of one embodiment comprises a test signal generator for generating a test signal, and delay logic for delaying the test signal. USB converter logic is coupled to the test signal generator. The USB converter logic includes logic for converting the test signal into a USB protocol signal. Circuitry is also provided for receiving the USB protocol signal and looping the signal back to the USB converter logic. Logic within the USB converter circuit converts the loop-backed signal into a loop-backed converted signal having a protocol compatible to the test signal. Finally, a comparator is included and coupled to the USB converter circuit. The comparator is configured to compare the loop-backed converted signal with the delayed test signal.

In addition, an embodiment of the present invention provides a method of testing a physical layer of a USB interface for a USB transceiver macrocell, comprising the steps of providing a test signal to the USB transceiver macrocell, sampling the test signal and outputting the test signal after a predetermined time, converting the test signal with USB protocol and outputting a converted signal by the USB transceiver macrocell, and comparing the converted signal with the test signal and then outputting an error acknowledging signal.

In another embodiment, the present invention provides a method of testing a USB transceiver. The method of this embodiment comprises providing a test signal to a USB signal converter and sampling the test signal and outputting the test signal after a predetermined time. The method also comprises the steps of converting the test signal with a USB protocol and outputting a converted signal by the USB signal converter, and comparing the converted signal with the test signal and then outputting an error-acknowledging signal.

### BRIEF DESCRIPTION OF THE DRAWINGS

The present invention will be more fully understood from the detailed description given hereinbelow and the accompanying drawings, given by way of illustration only and thus not intended to be limitative of the present invention.

FIG. 1 is a block diagram of the conventional USB interface.

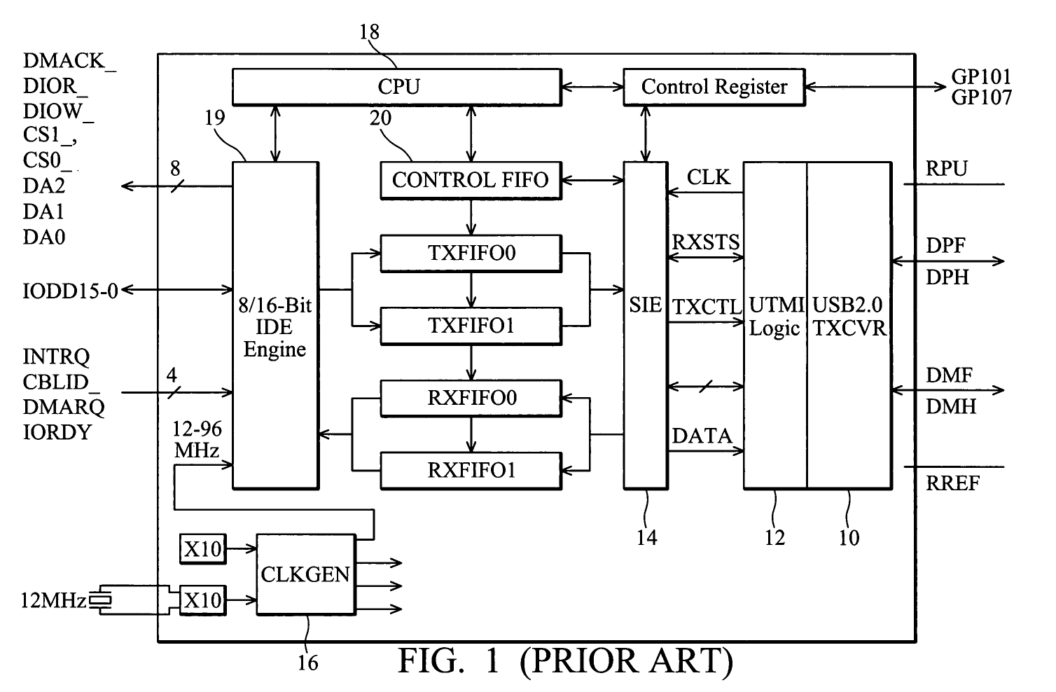

FIG. 2 is a block diagram of the physical layer of the USB interface according to one embodiment of the present invention.

FIG. 3 is a block diagram of a USB interface in accordance with another embodiment of the invention.

FIG. 4 is a flowchart showing the top-level operation of a method constructed in accordance with an embodiment of the invention.

### DETAILED DESCRIPTION OF THE INVENTION

USB provides an expandable, a hot-swappable Plug-n-Play serial interface that ensures a standard, low-cost connection for peripheral devices. Devices suitable for USB range from simple input devices such as keyboards, mice, and joysticks, to advanced devices such as printers, scanners, storage devices, modems, and video conferencing equipment. Migration to USB is recommended for all peripheral devices that use legacy ports such as the PS/2, serial, and parallel ports. USB 1.0 and 1.1 supports data transfer at up to 1.5 Mbps for low-speed devices and up to 12 Mbps for full-speed devices. Microsoft, HP, Compaq, Intel, Agere, NEC and Philips are seven core members of USB-IF to have worked on USB 2.0 standardization. USB 2.0 will support up to 480 Mbps for high-speed devices. USB 2.0 is suitable for high-performance devices such as high-quality video conferencing equipment, high-resolution scanners, and high-density storage devices. In addition, USB 2.0 supports legacy USB 1.0 and 1.1 software and peripherals.

To solve certain problems of testing the USB 2.0 interface as described above, the present invention discloses a new physical layer of the USB interface as the following embodiment.

Embodiment

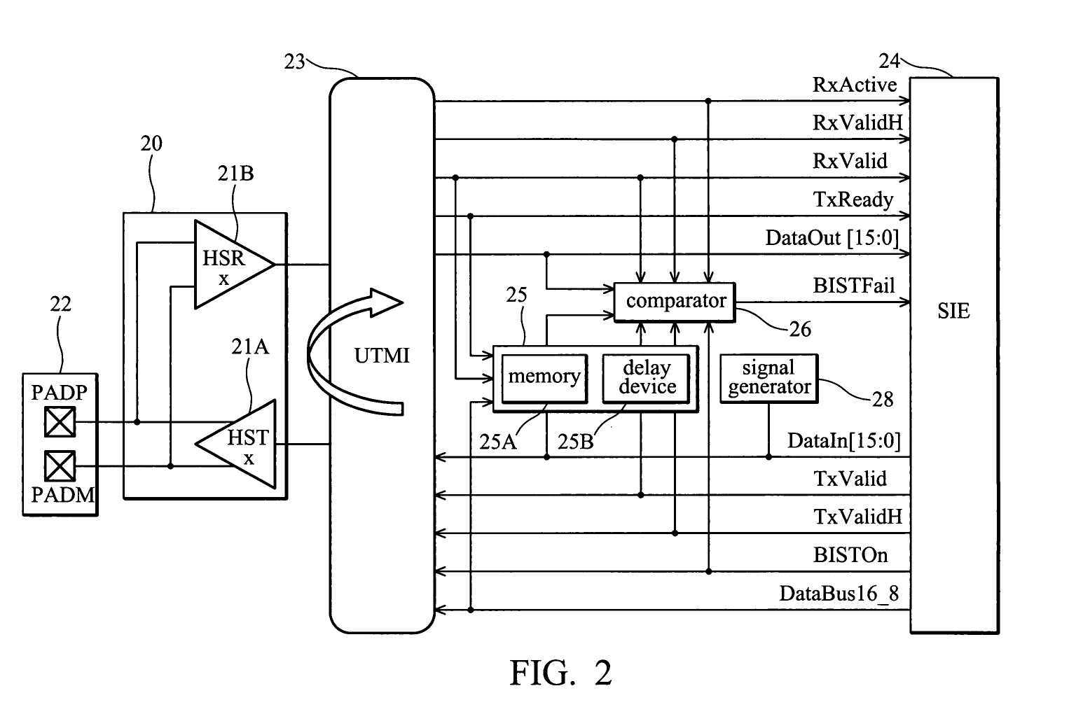

FIG. 2 shows a block diagram of the physical layer of the USB interface according to one embodiment of the present invention. The USB 2.0 transceiver 20 is the analog circuitry to handle the USB HS/FS signaling. The transmission terminals 22 communicate the data between the USB interface and the other device. The transmitter 21A outputs the signals output from the USB transceiver macrocell interface (UTMI) 23 to the transmission terminals 22, and the receiver 21B receives the signals of the transmission terminals 22 and outputs the data to the UTMI 23. Here, the output of the transmitter 21A and the input of the receiver 21B are electronically connected.

The UTMI 23 handles the low-level USB protocol and signaling. This includes features such as data serialization and deserialization, bit stuffing and clock recovery and synchronization. One function of UTMI 23 is to shift the clock domain of the data from the USB 2.0 rate to one that is compatible with the general logic in the ASIC.

The UTMI 23 is designed to support HS/FS, FS Only and LS Only UTM implementations. The three options allow a single serial interface engine (SIE) implementation to be used with any speed USB transceiver. A vendor can choose the transceiver performance that best meets their needs. A HS/FS implementation of the transceiver can operate at either a 480 Mbps or a 12 Mbps rate. Two modes of operation are required to properly emulate high-speed device connection and suspend/resume features of the USB 2.0 standard, as well as full-speed connections if implementing a dual-mode device. FS only and LS only UTM implementations do not require speed selection signals as there is no alternate speed to switch to. In addition, the UTMI 23 according to an embodiment of the present invention is compliant the Intel UTMI specification 1.09. The serial interface engine (SIE) 24 contains the USB packet ID and address recognition logic, and other sequencing and state machine logic to handle USB packets and transactions.

To test the accuracy of the signal transmission by the USB interface, an embodiment of the present invention provides a signal to be processed by the UTMI 23, and analyzes the processed signal output from the UTMI 23 to determine if the USB interface is operating properly. During the testing operation, an enable pin BISTOn provides a testing enable signal to indicate that the physical layer of the USB interface is being tested. Here, the testing enable signal can be output by the serial interface engine 24 or controlled externally from USB transceiver macrocell.

A signal generator 28 generates a signal to be tested. The signal to be tested is sampled by a signal-sampling device 25, which is coupled to the signal generator 28 with a predetermined frequency. The signal sampling device 25 comprises a memory 25A to register the sampled signal and a delay device 25B to delay the sampled signal for a predetermined time. As will be further described below, this delay allows the signal tested to be synched with the signal that is passed through the USB interface, transmitted and looped-back through the transmission terminals, and passed back through the USP interface. Thus, “predetermined,” with reference to the predetermined time, is not necessarily a fixed (known) time, but could also be a variable time delay.

The USB transceiver macrocell 23 is coupled to the signal generator 28 to convert the signal to be tested with USB 2.0 protocol. The first converted signal is output from the transmitter 21A and fed back to the USB transceiver macrocell 23 through the transmission terminals 22 and the receiver 21B. Next, the USB transceiver macrocell 23 converts the received first converted signal again to a second converted signal. Here, the signal to be tested and the second converted signal are parallel signals, and the first converted signal is a serial signal.

The comparator 26 is coupled to the USB transceiver macrocell 23 and the signal sampling device 25 for comparing the second converted signal output from the USB transceiver macrocell 23 and the sampled signal output from the signal sampling device 25. As describe above, the sampled signal is delayed by the delay device 25B for a predetermined time, which is designed according to the USB protocol implemented by the USB transceiver macrocell 23 to make the signal sampling device 25 output the sampled signal and the USB transceiver macrocell 23 output the second converted signal at the same time. Here, the USB protocol implemented by the USB transceiver macrocell 23 according to the present invention is the USB 2.0 specification.

Therefore, if errors occur during the signal conversion of the USB transceiver macrocell 23 and the transmission in the USB 2.0 transceiver 20, the second converted signal and the sampled signal received by the comparator 26 are different, thus the comparator 26 outputs an error acknowledging signal from the pin BISTFail.

According to one embodiment of the present invention, the signal generator 28 can be merged with the physical layer of the USB interface to test the USB interface internally or set up outside from the USB interface with flexible test signals and the patterns of the test signal can be changed dynamically.

In addition, only the pin BISTFail may be monitored when the signal of the enable pin BISTOn is asserted, thus reducing the amount of bandwidth required to test the physical layer of the USB 2.0 interface and feed the test signal at a very low speed of 30 MHz, which is the frequency of the 16-bit data bus.

Other features and benefits of embodiments of the invention include low test cost due to the use of a digital tester, practical bus data rate of 30 MHz, applicable to both 8-bit and 16-bit interface and completely independent module to test the USB transceiver macrocell interface.

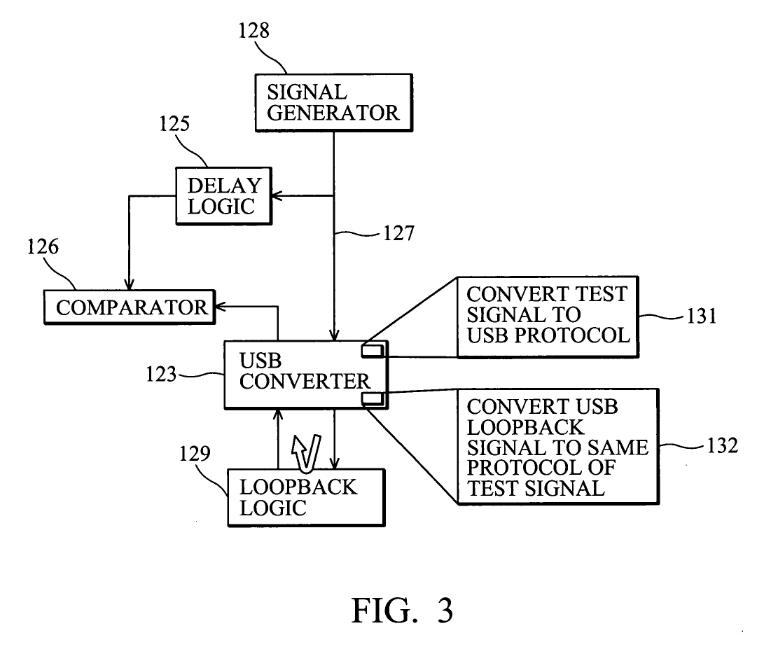

As will be understood by persons skilled in the art, the foregoing is illustrative of the inventive features in one particular embodiment, and that the invention may be implemented in other embodiments as well. In this regard reference is made to FIG. 3, which is a block diagram of an alternative embodiment of a USB interface constructed in accordance with the invention. A detailed discussion of the various blocks of FIG. 3 need not be provided, as the general structure and operation will be understood in view of the discussion provided of FIG. 2.

Briefly stated, a signal generator 128 generates a test signal 127. The test signal 127 is input to a USB converter logic block 123. The USB converter includes logic 131 that converts the test signal into a USB protocol. The USB converter logic 123 outputs the converted signal to logic 129, which loops the signal back to the USB converter logic 123. The USB converter logic 123 also includes logic 132 that converts the looped-back signal back to a signal that is compatible with the test signal 127. This loop-backed converted signal is compared (by comparator 126) against a delayed version of the test signal 127.

In this regard, delay logic 125 delays the test signal 127 by an amount that is commensurate to the delay encountered by the test signal in passing through the USB converter logic 123, the loop-back delay logic 129, and back through the USB converter logic 123. The delay logic 125, as well as the other components illustrated in FIG. 3, may be implemented in a variety of ways consistent with the scope and spirit of the present invention.

Although not specifically illustrated in FIG. 3, the comparison made by comparator 126 may be implemented in a variety of ways. Simply stated, any differences between the two compared signals provides information about the accuracy of the signal conversions made by the USB converter logic 123.

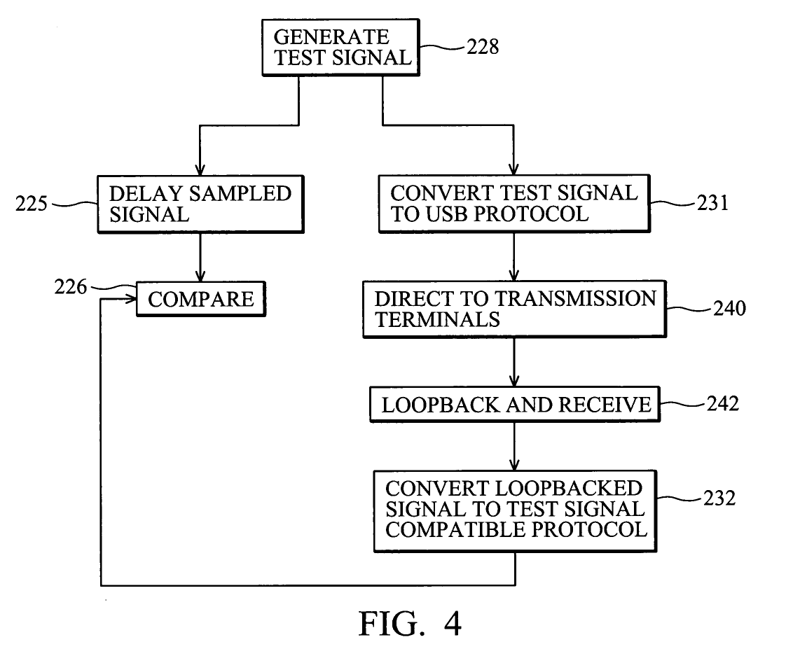

Having described certain embodiments of a USB interface, reference is now made to FIG. 4, which illustrates the top-level operation of a method of testing a USB interface, in accordance with another embodiment of the invention. As illustrated, a test signal is generated (228). The test signal is converted into a USB protocol signal (231). That USB protocol signal is directed to transmission terminals (240) and is looped-back and received by receive terminals (242). Then, the loop-backed signal is converted back to a signal protocol that is compatible with the test signal (232). Meanwhile, the test signal is also delayed (225), such that when the loop-backed signal is converted, the resultant signal may be compared (226) with the test signal.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A USB interface, comprising:
a test signal generator for generating a test signal;
a signal sampling device coupled to the test signal generator for sampling the test signal and outputting the sampled test signal after a predetermined time;
a transmitter and a receiver coupled to a signal for accessing data at transmission terminals;
a USB transceiver macrocell coupled to the test signal generator, the transmitter, and receiver, the USB transceiver macrocell for converting the test signal with USB protocol, outputting a first converted signal through the transmitter, receiving the first converted signal through the transmission terminals and the receiver, and converting the received first converted signal to a second converted signal; and
a comparator coupled to the USB transceiver macrocell and the signal sampling device for comparing the second converted signal with the sampled test signal, and outputting an error-acknowledging signal.

2. The USB interface as claimed in claim 1, wherein the predetermined time is set according to the USB protocol implanted by the USB transceiver macrocell.

3. The USB interface as claimed in claim 1, wherein the signal sampling device further comprising:
a memory for storing the test signal; and
a delay device for delaying the test signal for the predetermined time, and outputting the test signal from the memory.

4. The USB interface as claimed in claim 1, wherein the test signal and the second converted signal are parallel signals.

5. The USB interface as claimed in claim 4, wherein the first converted signal is a serial signal.

6. The USB interface as claimed in claim 5, wherein the USB transceiver macrocell converts the parallel test signal to the serial first converted signal, and converts the first converted signal received by the receiver to the parallel second converted signal.

7. The USB interface as claimed in claim 1, wherein the comparator further comprises an enable terminal and is enabled when the enable terminal receives a testing enable signal representing the test of the physical layer of the USB interface is performed.

8. The USB interface as claimed in claim 7, further comprising a serial interface engine coupled to the USB transceiver macrocell containing a USB packet ID and address recognition logic, sequencing and state machine logic to handle USB packets and transactions.

9. The USB interface as claimed in claim 8, wherein the testing enable signal is output by the serial interface engine or controlled externally from USB transceiver macrocell.

10. A testing method for a USB interface, comprising the following steps:
providing a test signal to a USB transceiver macrocell;
sampling the test signal and outputting the test signal after a predetermined time;
converting the test signal to USB protocol, outputting a first converted signal through a transmitter, receiving the first converted signal through a receiver, and converting the received first converted signal to a second converted signal; and
comparing the second converted signal with the test signal and then outputting an error-acknowledging signal.

11. The testing method of claim 10, wherein the predetermined time is set according to the USB protocol implanted by the USB transceiver macrocell.

12. The testing method of claim 10, wherein the test signal and the second converted signal are parallel signals.

13. The testing method of claim 12, wherein the first converted signal is a serial signal.

14. The testing method of claim 13, wherein the USB transceiver macrocell converts the parallel test signal to the serial first converted signal, and converts the first converted signal received by the receiver to the parallel second converted signal.

15. A testing method for a USB transceiver macrocell, comprising the following steps:
providing a test signal to the USB transceiver macrocell;
sampling the test signal and outputting the test signal after a predetermined time;
converting the test signal with a USB protocol and outputting a converted signal by the USB transceiver macrocell; and
comparing the converted signal with the test signal and then outputting an error-acknowledging signal.

16. The testing method of claim 15, wherein the predetermined time is set according to the USB protocol implanted by the USB transceiver macrocell.

17. A USB interface, comprising:
a test signal generator for generating a test signal;
delay logic for delaying the test signal;
a USB converter logic coupled to the test signal generator,
the USB converter logic including logic for converting the test signal into a USB protocol signal,
circuitry for receiving the USB protocol signal and looping the signal back to the USB converter logic;
logic within the USB converter circuit for converting the loop-backed signal into a loop-backed converted signal having a protocol comparable to the test signal; and
a comparator coupled to the USB converter circuit, the comparator configured to compare the loop-backed converted signal with the delayed test signal.

18. A testing method for a USB transceiver, comprising:
providing a test signal to a USB signal converter;
sampling the test signal and outputting the test signal after a predetermined time;
converting the test signal with a USB protocol and outputting a converted signal by the USB signal converter; and
comparing the converted signal with the test signal and then outputting an error-acknowledging signal.
